(19) United States
(12) Patent Application Publication
(10) Pub. No.: US 2026/0106241 A1
(43) Pub. Date: Apr. 16, 2026

(54) BATTERY PROCESSING METHOD AND BATTERY PROCESSING SYSTEM

(71) Applicant: MAZDA MOTOR CORPORATION, Hiroshima (JP)

(72) Inventors: Susumu MINEOI, Hiroshima (JP); Tenyu YAN, Hiroshima (JP); Kenjiro MOMOSAKI, Hiroshima (JP); Tomoki YAMAMOTO, Hiroshima (JP)

(73) Assignee: MAZDA MOTOR CORPORATION, Hiroshima (JP)

(21) Appl. No.: 19/335,018

(22) Filed: Sep. 22, 2025

(30) Foreign Application Priority Data
Oct. 11, 2024 (JP) 2024-179302

(51) Int. Cl. H01M 10/44; H01M 4/38; H01M 10/0525; H01M 10/54; H01M 10/613

(52) U.S. Cl. CPC H01M 10/443; H01M 4/382; H01M 10/0525; H01M 10/54; H01M 10/613

(57) ABSTRACT

A battery processing method for processing the lithium-ion battery including a positive electrode material and a negative electrode material includes: a first step of charging the lithium-ion battery while cooling to deposit lithium on the negative electrode material; a second step of increasing a temperature of the lithium-ion battery; and a third step of charging the lithium-ion battery while cooling again to deposit lithium on the negative electrode material.

### CROSS-REFERENCE TO RELATED APPLICATION

The present application claims priority to Japanese Patent Application 2024-179302, filed Oct. 11, 2024, the entire contents of which are incorporated herein by reference.

### FIELD

Embodiments relate to a battery processing method and a battery processing system.

### Background Art

In recent years, lithium-ion batteries have been widely used as in-vehicle batteries of electric-powered vehicles such as electric vehicles and hybrid vehicles. The lithium-ion battery contains valuable substances including lithium. It is requested to recycle valuable substances from the used lithium-ion batteries for resource circulation.

Patent Literature 1 discloses a method for increasing an amount of lithium contained in a positive electrode material by discharging the used lithium-ion battery to collect lithium from the positive electrode material.

### CITATION LIST

### Patent Literature

[Patent Literature 1] JP-A-2022-049831

### SUMMARY

The positive electrode material is generally configured by forming a positive electrode active material on a current collector foil such as aluminum. For example, in a case of a ternary system (NMC), the positive electrode active materials include the valuable substances such as nickel, manganese, and cobalt. In order to collect the valuable substances from the positive electrode active material, the positive electrode material is roasted together with a reducing agent and pulverized, and then a black mass or the like containing the positive electrode active material is selected. Next, the black mass is subjected to stepwise solvent extraction to sequentially extract manganese, cobalt, and nickel, and finally lithium is extracted. Thus, it takes time and effort to collect lithium in particular.

One or more embodiments may provide a battery processing method and a battery processing system capable of efficiently collecting lithium from a lithium-ion battery.

One or more embodiments may provide
a battery processing method for processing a lithium-ion battery including a positive electrode material and a negative electrode material, the battery processing method including:
a first step of charging the lithium-ion battery while cooling to deposit lithium on the negative electrode material;
a second step of returning a temperature of the lithium-ion battery to a room temperature; and
a third step of charging the lithium-ion battery while cooling again to deposit lithium on the negative electrode material.

### ADVANTAGEOUS EFFECTS

According to an embodiment, lithium can be efficiently collected from a negative electrode of the lithium-ion battery.

### BRIEF DESCRIPTION OF DRAWINGS

FIG. 1 is a block diagram schematically illustrating a reuse system according to a first embodiment.

FIG. 2 is a perspective view illustrating a schematic configuration of a lithium-ion battery.

FIG. 3 is a cross-sectional view illustrating a schematic configuration of a battery cell.

FIG. 4 is a flowchart schematically illustrating a flow of reuse of the lithium-ion battery.

FIG. 5 is a schematic view schematically illustrating an example of a cooling device according to the first embodiment.

FIG. 6 is a graph illustrating a relationship between a charging rate with respect to state of charge (SOC) and ease of deposition of lithium at each cooling temperature.

### DETAILED DESCRIPTION

The present inventors have conducted intensive studies to efficiently collect lithium from a lithium-ion battery, and have found that lithium can be efficiently collected from the lithium-ion battery by intentionally generating lithium deposition (for example, dendrite), which is not desirable in a normal charging reaction, on a negative electrode material. Based on this finding, the present inventors have completed a battery processing method capable of efficiently collecting lithium from the lithium-ion battery.

A method for reusing a lithium-ion battery according to an embodiment is
a battery processing method for processing a lithium-ion battery including a positive electrode material and a negative electrode material, the battery processing method including:
a first step of charging the lithium-ion battery while cooling it to deposit lithium on the negative electrode material;
a second step of returning the lithium-ion battery to a room temperature; and
a third step of charging the lithium-ion battery while cooling it again to deposit lithium on the negative electrode material.

### First Embodiment

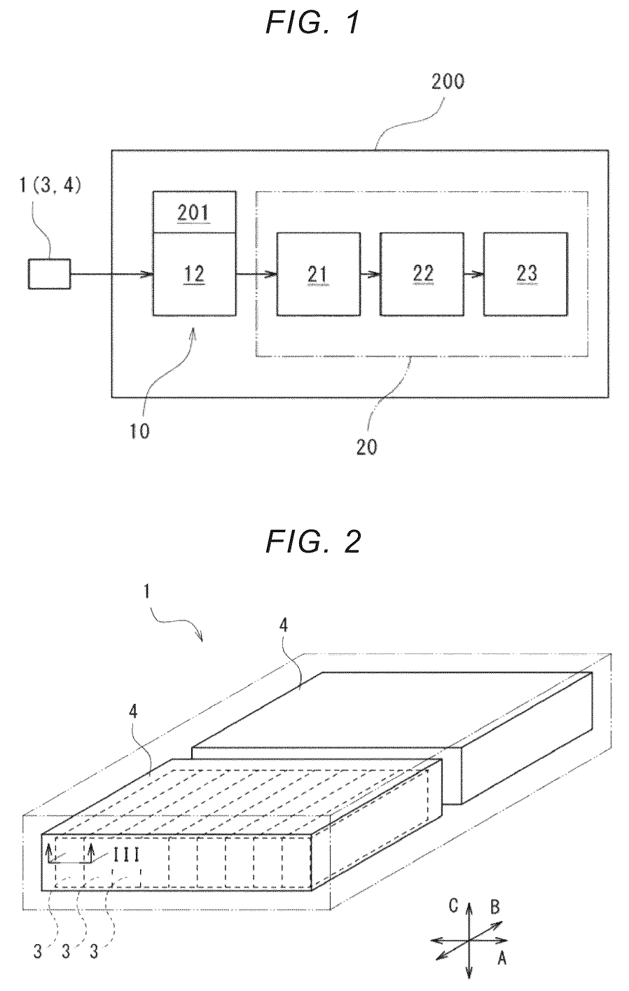

Hereinafter, a reuse system of a lithium-ion battery according to a first embodiment will be described with reference to the accompanying drawings. FIG. 1 is a block diagram schematically illustrating a reuse system 200 of a lithium-ion battery 1. As illustrated in FIG. 1, the reuse system 200 includes: a reuse unit 10 secondarily using the lithium-ion battery 1 that has been used primarily in an electric-powered vehicle, for example; and a recycle unit 20 collecting lithium from the lithium-ion battery 1 that has been used secondarily.

The reuse unit 10 reuses the lithium-ion battery 1, which has been used primarily, as an electrical storage device. In general, a deteriorated state of the lithium-ion battery for the electric-powered vehicle is determined on the basis of state of health (SOH) that indicates, for example, how much capacity is available in comparison with a new battery when the battery is fully charged. When it is determined that the lithium-ion battery 1 is inappropriate for use in the electric-powered vehicle on the basis of a degree of the deterioration, it is removed from the vehicle, and is used in the reuse unit 10 as the electrical storage device for any of various secondary applications, such as a storage of renewable energy including solar power and wind power and a backup power source in the event of a disaster. For example, when the SOH becomes 70% or less, it may be determined that it is inappropriate for the primary use, that is, for use in the electric-powered vehicle.

The reuse unit 10 includes the lithium-ion battery 1, which is used secondarily as the electrical storage device, a charging device 12, and a cooling/temperature increasing device 201. The charging device 12 can charge the lithium-ion battery 1 in any appropriate charging pattern by adjusting voltage and current. For example, the lithium-ion battery 1 can be charged continuously with a predetermined voltage and a predetermined current, and can also be charged intermittently with the predetermined voltage and the predetermined current (also referred to as pulse charging). An upper limit of a charging voltage by the charging device 12 is a withstand voltage of the lithium-ion battery 1 or less, and is 4.3 V or less, for example.

The recycle unit 20 includes: a disassembly device 21 that disassembles the lithium-ion battery 1 into a positive electrode material 31, a negative electrode material 35, and the like through a lithium deposition step described below when it is determined that the lithium-ion battery 1 can be inappropriate for secondary use on the basis of the SOH, for example; an extraction device 22 that extracts lithium from the negative electrode material 35 after the disassembly; and a collection device 23 that collects extracted lithium. For example, when the SOH becomes 40% or less, it may be determined that it can be inappropriate for the secondary use.

FIG. 2 schematically illustrates the lithium-ion battery 1 that is mounted on the electric-powered vehicle. The lithium-ion battery 1 constitutes a battery pack having battery modules 4, each of which incorporates functions as a charge/discharge circuit and a cooling mechanism. Furthermore, the plural battery modules 4 are connected to each other and accommodated in a case. Each of the battery modules 4 is formed by connecting plural battery cells 3 in series or in parallel with each other, and is adjusted to desired capacity and a desired voltage.

The lithium-ion battery 1 is a rechargeable lithium-ion secondary battery. In the present specification, the term “lithium-ion battery” may collectively refer to the battery cell, the battery module, and the battery pack unless otherwise specified.

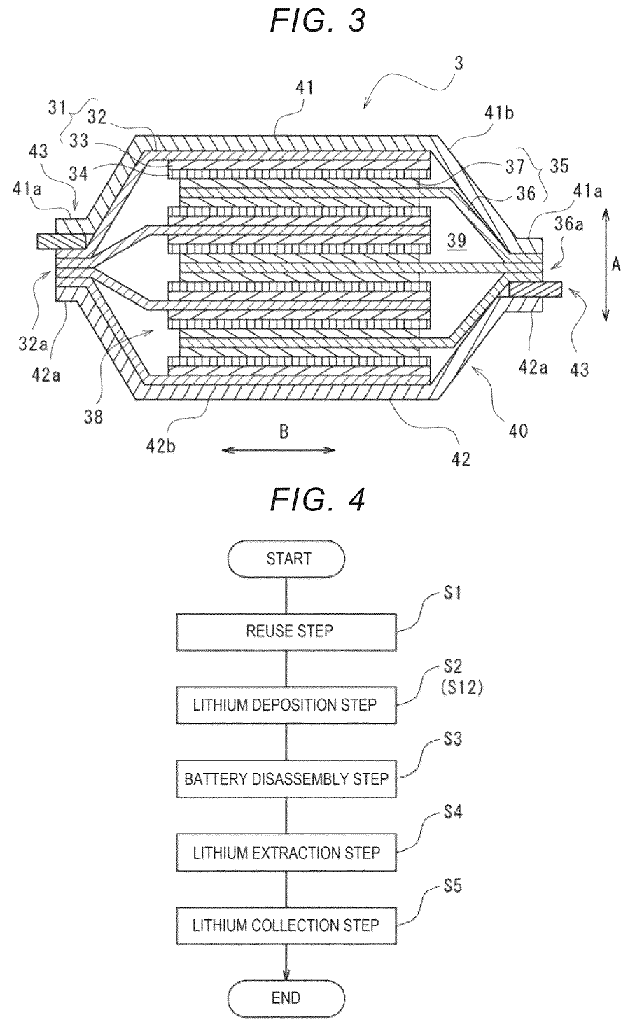

FIG. 3 is a cross-sectional view schematically illustrating the battery cell 3. As illustrated in FIG. 3, the battery cell 3 according to the present embodiment is of a laminated type. The battery cell 3 includes: a laminated electrode body 38 in which the positive electrode material 31, a separator 34, and the negative electrode material 35 are laminated in this order in a lamination direction A; and a case 40 that accommodates the laminated electrode body 38.

In the present embodiment, the laminated electrode body 38 is formed by laminating plural sets of the positive electrode material 31, the separator 34, and the negative electrode material 35 in the lamination direction A. The battery cell 3 has a rectangular shape that is thin and long in a width direction B when viewed in the lamination direction A.

The positive electrode material 31 includes a positive electrode current collector 32 and a positive electrode active material 33 that is disposed on a surface of the positive electrode current collector 32 facing the separator 34. In a positive electrode current collector end portion 32a, the plural positive electrode current collectors 32 are connected to each other at one end (a left side in FIG. 3) in the width direction B that is orthogonal to the lamination direction A. A metal foil suitable for a positive electrode can be suitably used for each of the positive electrode current collectors 32. A material that is used as a positive electrode active material of a lithium-ion secondary battery can be used as the positive electrode active material 33. In the present embodiment, each of the positive electrode current collectors 32 is made of aluminum, and the positive electrode active material 33 is made of NMC (nickel, manganese, and cobalt).

The negative electrode material 35 includes a negative electrode current collector 36 and a negative electrode active material 37 that is disposed on a surface of the negative electrode current collector 36 facing the separator 34. In a negative electrode current collector end portion 36a, the plural negative electrode current collectors 36 are connected to each other at the other end (a right side in FIG. 3) in the width direction B. A metal foil suitable for a negative electrode can be suitably used for each of the negative electrode current collectors 36. A material that is used as a negative electrode active material of the lithium-ion secondary battery can be used for the negative electrode active material 37. In the present embodiment, each of the negative electrode current collectors 36 is made of copper, and the negative electrode active material 37 is a carbon material (graphite) that has a layer structure.

The positive electrode active material 33 and the negative electrode active material 37 each contain an electrolytic solution 39. The electrolytic solution 39 is, for example, an organic solvent in which lithium ions can move. In the present embodiment, the electrolytic solution 39 contains dimethyl carbonate (DMC), ethylene carbonate (EC), and diethyl carbonate (DEC) in a volume ratio of 1:1:1, and contains lithium hexafluoride phosphate (LiPF₆) at a concentration of 1 mol/L.

The separator 34 is disposed between the positive electrode material 31 and the negative electrode material 35, and physically and electrically separates them from each other. The separator 34 may be a porous body having plural minute pores through which the lithium ions can pass. In the present embodiment, the separator 34 is a porous film that is made of polyolefin.

The case 40 has a first case 41 and a second case 42 that are provided as a pair on both sides in the lamination direction A of the laminated electrode body 38. The first case 41 and the second case 42 are each formed to have a hat-shaped cross section. The first case 41 includes: a pair of flange portions 41a located at both ends in the width direction B; and a body portion 41b that is located between the paired flange portions 41a and bulges in a direction away from the second case 42 in the lamination direction A. Similarly, the second case 42 includes a pair of flange portions 42a and a body portion 42b that bulges in a direction away from the first case 41.

The first case 41 and the second case 42 are joined to each other in a state of sandwiching the positive electrode current collector end portion 32a and the negative electrode current collector end portion 36a between the flange portions 41a, 42a, and thereby constitute the case 40. That is, in a state where the laminated electrode body 38 is accommodated in the case 40, the positive electrode current collector end portion 32a and the negative electrode current collector end portion 36a are sandwiched between the paired flange portions 41a, 42a, and a remaining portion of the laminated electrode body 38 is accommodated in a space that is defined between the paired body portions 41b, 42b. In the state of being accommodated in the case 40, the laminated electrode body 38 is crimped with a predetermined pressure in the lamination direction A by the paired body portions 41b, 42b. An example of a tab 43 according to an embodiment is formed by a portion, which is sandwiched by the paired flange portions 41a, 42a, in the battery cell 3.

Next, reuse of the lithium-ion battery 1 will be described. FIG. 4 is a flowchart schematically illustrating a flow of reuse of the lithium-ion battery 1. As illustrated in FIG. 4, when it is determined that the lithium-ion battery 1, which is mounted on the electric-powered vehicle, is in the deteriorated state that is not suitable for use in the electric-powered vehicle on the basis of the SOH, for example, a reuse step (step S1) is executed. In the reuse step S1, the lithium-ion battery 1 is removed from the electric-powered vehicle and used secondarily in the reuse unit 10.

In a case where it is determined that the lithium-ion battery 1 is in a predetermined deteriorated state after being used secondarily as the electrical storage device, a lithium deposition step (step S2) is executed following the secondary use in the reuse unit 10. In the lithium deposition step S2, the lithium-ion battery 1 is charged to deposit lithium on the negative electrode material 35. The lithium deposition step S2 includes:
a first step of charging the lithium-ion battery 1 while cooling to deposit lithium on the negative electrode material 35;
a second step of increasing a temperature of the lithium-ion battery 1; and
a third step of charging the lithium-ion battery 1 while cooling again to deposit lithium on the negative electrode material 35.

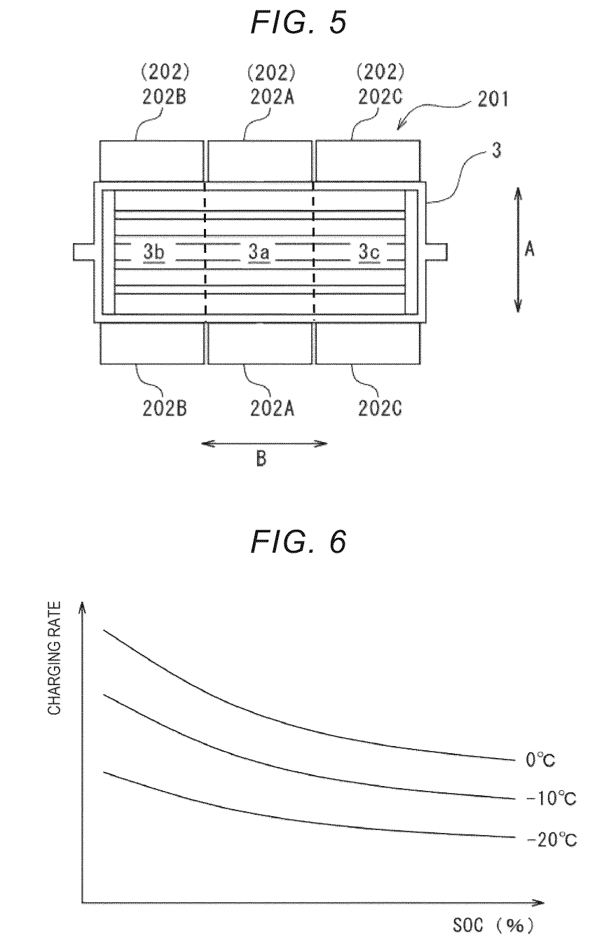

FIG. 5 is a view schematically illustrating the cooling/temperature increasing device 201. FIG. 5 also schematically illustrates the battery cell 3 that is cooled or whose temperature is increased by the cooling/temperature increasing device. As illustrated in FIG. 5, a pair of the cooling/temperature increasing devices 201 is provided on both sides of the battery cell 3 in the lamination direction A. In addition, it may be configured that, in one of the paired cooling/temperature increasing devices 201, a single cooler/temperature increasing element covers the entire battery cell 3 in the width direction B, or, as illustrated in FIG. 5, it may be configured to provide plural sets of cooler/temperature increasing element pairs 202 that are divided in the width direction B of the battery cell 3. In the present embodiment, a central cooler/temperature increasing element pair 202A for cooling a central portion 3a of the battery cell 3 and cooler/temperature increasing element pairs 202B, 202C for respectively cooling both side portions 3b, 3c of the battery cell 3 are provided. The number of the cooler/temperature increasing element pairs 202 may be three, or may be divided into two, four, or more. For example, when the battery cell 3 is cooled only by the central cooler/temperature increasing element pair 202A, lithium is preferentially or selectively deposited in the negative electrode material 35 that is located in a central portion in the width direction B. In an implementation, the cooler/temperature increasing element may be in the form of the pair, or may be disposed only on one side (an upper side or a lower side in FIG. 5) in the lamination direction A, for example.

The cooling/temperature increasing device 201 may be a cooling/temperature increasing device of any appropriate type. For example, a thermostatic bath may be adopted as the cooling/temperature increasing device 201. In addition, the cooling/temperature increasing device 201 may be a device that includes a cooling device and a temperature increasing device as separate devices. Alternatively, for example, cooling may be performed in the thermostatic bath, and the temperature may be increased in an oven.

In a first step, the lithium-ion battery 1 is charged while being cooled by the cooling/temperature increasing device 201 under a predetermined cooling condition. Here, a graph in FIG. 6 illustrates a relationship between a charging rate with respect to state of charge (SOC) and ease of deposition of lithium at each temperature. More specifically, when charging is performed in a region above a curve at each temperature, the deposition of lithium is facilitated on the negative electrode material 35. The SOC is an index indicating a charged state of the battery, and indicates battery capacity at the time when a fully charged state is set as 100% and a completely discharged state is set as 0%. As illustrated in FIG. 6, lithium is more likely to be generated as the SOC of the lithium-ion battery 1 is increased and/or as the temperature thereof is reduced.

Thus, in the first step, the lithium-ion battery 1 is charged at the charging rate and a cooling temperature, at which lithium is deposited on the negative electrode material 35.

The cooling temperature varies by a use environment, a type, and the like of the lithium-ion battery 1. However, when the lithium-ion battery 1 is of a so-called capacitive type (also referred to as an energy type) that is mounted on an electric vehicle, it can be 20° C. or less, 10° C. or less, 0° C. or less, −5° C. or less, −10° C. or less, −20° C. or less, or −30° C. or less, and can be −50° C. or more, −40° C. or more, −30° C. or more, −25° C. or more, or −20° C. or more. From a viewpoint of reliably depositing lithium on the cooled portion, the temperature may be −10° C. or less. In addition, in order to prevent the deposition of lithium on the entire lithium-ion battery 1 due to excessive cooling, the cooling temperature may be −50° C. or more or −40° C. or more. In one aspect, the cooling temperature can be from −40° C. to 10° C.

A cooling rate during cooling may be 0.1° C./min to 10° C./min, for example. From a viewpoint of unevenly distributing deposition positions of lithium, the cooling rate may be 1° C./min to 10° C./min. In the present disclosure, the “cooling rate” and a “temperature increasing rate” are parameters that are based not on a temperature of a surrounding environment but on a temperature inside the battery.

Thus, in the first step, the lithium-ion battery 1 is charged while being cooled.

As a result, lithium can be deposited on a part of the negative electrode material 35 without high-rate charging, and a charging current can be suppressed. Thus, energy can be saved.

Here, in the lithium deposition step S2, the lithium-ion battery 1 only needs to be charged in the cooled state. Cooling of the lithium-ion battery 1 by the cooling/temperature increasing device 201 and charging of the lithium-ion battery 1 by the charging device 12 may be started simultaneously, or one thereof may be started first. That is, after being cooled by the cooling/temperature increasing device 201, it may be charged by the charging device 12 while maintaining a cooled state by the cooling/temperature increasing device 201.

Meanwhile, in the first step, in a case where charging, which is performed while only a part of the lithium-ion battery 1 is cooled, is not the high-rate charging, there is a possibility that the deposition of lithium in the cooled portion is suppressed due to progress of a normal charging reaction in a non-cooled portion. Thus, charging may be performed by the high-rate charging.

In the present specification, the high-rate charging means charging with a large current that intentionally generates lithium in the negative electrode material 35 during charging.

For example, when the lithium-ion battery 1 is of the capacitive type, it may be charged with the current of 2 C or more, for example. Meanwhile, when the lithium-ion battery 1 is of a so-called high-output type (also referred to as a power type) that is mounted on a hybrid vehicle, it may be charged with a current of 10 C or greater, for example. Here, the current of 1 C means a current that is required to fully charge each of the lithium-ion batteries in one hour. Lithium can be deposited further efficiently on the negative electrode material 35 by the continuous high-rate charging for a predetermined time.

In the present specification, the lithium-ion battery 1 being of the capacitive type means a case where the energy density thereof is 600 Wh/L or greater. In addition, the lithium-ion battery 1 being of the high-output type means a case where the output density (kW/kg or kW/L) is 4000 kW/L or more.

When the charging current in the high-rate charging becomes excessively large, unfavorable side reactions, such as gasification of the electrolytic solution 39 and deformation and damage of each component, possibly occur due to heat generation. Thus, from a viewpoint of energy saving, excessive charging current is not preferable. For example, when the lithium-ion battery 1 is of the capacitive type, an upper limit of the charging current may be set to about 3 C. Meanwhile, when the lithium-ion battery 1 is of the high-output type, the upper limit of the charging current may be set to about 20 C.

Next, in the second step, the cooling/temperature increasing device 201 increases the temperature of the lithium-ion battery 1 to a predetermined temperature. Lithium that has been deposited on the negative electrode material 35 in the first step is ionized by the temperature increase and then absorbed by the negative electrode active material 37 (for example, graphite) in the negative electrode material 35. At this time, since the temperature increase is accompanied by a reduction in viscosity of the electrolytic solution 39 and an increase in mobility of lithium ions, lithium ions are preferentially absorbed into a portion with high lithium ion absorption capacity in the negative electrode active material 37. Thus, a part of the negative electrode active material 37 after completion of the second step can be in a state of absorbing a larger amount of lithium ions than that before the first step.

In the second step, the temperature may be increased to a room temperature. In the present specification, the term “room temperature” refers to a temperature within a range of 5° C. to 35° C. Accordingly, in the second step, the temperature of the lithium-ion battery 1 can be increased to 5° C. to 35° C., e.g., may be to 15° C. to 25° C.

In the second step, the temperature may be increased by leaving the lithium-ion battery 1 in a room temperature environment for a predetermined time, or the temperature may be increased by heating. A heating method may be a suitable method, e.g., a hot water bath or an oven.

The temperature increasing rate during heating may be 0.1° C./min to 20° C./min, for example. From a viewpoint of unevenly distributing deposition positions of lithium lastly, the temperature increasing rate may be 1° C./min to 10° C./min.

In addition, in the second step, discharge may be performed, e.g., the lithium-ion battery 1 may be discharged, while the temperature is increased. By discharging while increasing the temperature, it is possible to improve efficiency of charging in the subsequent third step. At this time, the discharge may be performed at the same rate as the rate at which charging is performed in the first step, for example. Furthermore, the discharge is not only performed while the temperature is increased. For example, in the second step, the temperature may be increased after the discharge is performed first, or the discharge may be performed after the temperature is increased. From a viewpoint of generating a normal discharge reaction in the lithium-ion battery 1, the discharge may be performed while the temperature is increased or after the temperature is increased.

Next, in the third step, the lithium-ion battery 1 is charged while being cooled again to deposit lithium on the negative electrode material 35.

A charging condition and a cooling condition in the third step may be any of the conditions listed in the first step. Alternatively, the charging condition and the cooling condition in the third step may be different conditions from those in the first step depending on the battery deteriorated state, a lithium ion absorption state of the negative electrode active material 37, and the like. For example, in the third step, from a viewpoint of depositing a larger amount of lithium than that in the first step, the cooling temperature may be 1° C., 2° C., 3° C., 5° C., 7° C., or 10° C. less than that in the first step.

A part of the negative electrode active material 37, which has absorbed the large amount of lithium upon completion of the second step, is cooled in the third step. Thus, upon completion of the third step, a lithium deposition amount in the part of the negative electrode active material 37 can be larger than the lithium deposition amount upon completion of the first step. Thus, in the first to third steps described above, lithium can be deposited on the entire negative electrode material 35 in a state where the lithium deposition amount in the part of the negative electrode material 35 is larger than that in the other portions.

Next, the lithium-ion battery 1 is removed from the reuse unit 10, and a battery disassembly step (step S3) is executed by the disassembly device 21. In the battery disassembly step, the lithium-ion battery 1 is disassembled into components such as the positive electrode material 31, the separator 34, the negative electrode material 35, and the case 40. When only lithium is intended to be collected, at least the negative electrode material 35 may only be disassembled. The disassembly device 21 may be any appropriate device that automatically disassembles the lithium-ion battery 1. Here, the lithium-ion battery 1 may be disassembled manually by using a tool or the like without using the disassembly device 21.

Next, a lithium extraction step (step S4) is executed to extract lithium from the disassembled negative electrode material 35. In the lithium extraction step, after the negative electrode material 35 is exuded with water and then filtered, the negative electrode current collector 36 and the negative electrode active material 37 are removed from the negative electrode material 35, and an aqueous solution containing lithium ions is thereby extracted.

In addition, in the disassembled negative electrode material 35, the portion having the larger lithium deposition amount than the other portions in the third step or fourth step of the lithium deposition step S2 is selectively subjected to the lithium extraction step S4. In this way, lithium can be efficiently extracted.

Finally, a lithium collection step (step S5)is executed to collect lithium from the aqueous solution containing lithium ions. In the lithium collection step, after lithium is subjected to a solution treatment with carbonated water and then filtered, lithium is collected as lithium carbonate.

As a result, since the negative electrode material 35 is generally formed by laminating graphite on the current collector foil, such as copper, in the form of the layer, it contains less types of valuable substances than the positive electrode material 31 that has plural types of the valuable substances such as cobalt, nickel, and manganese. Accordingly, unlike a case where lithium is collected from the positive electrode material 31, stepwise solvent extraction of plural types of the valuable metals does not require time and effort. Thus, lithium can be efficiently collected from the negative electrode material 35.

In the first embodiment described above, the description has been made on the case where, after the lithium-ion battery 1 is subjected to the reuse step S1 in the form of the battery pack, the lithium deposition step S2 is executed. In the reuse step S1 and/or the lithium deposition step S2, the lithium-ion battery 1 may be subjected in the form of the battery module 4 or the battery cell 3.

### Second Embodiment

The second embodiment differs in that a second lithium deposition step S12 is employed instead of the lithium deposition step S2 according to the first embodiment. The second lithium deposition step S12 includes from the first step to the third step as in the lithium deposition step S2, and further includes a fourth step that is repeated or performed at least once. In the fourth step, after the third step, the temperature of the lithium-ion battery is increased to the room temperature, and it is then again charged while being cooled to deposit lithium on the negative electrode material.

In the fourth step, the temperature increase, cooling, and charging may be performed under the same conditions as those listed in the first to third steps. In addition, similar to the second step, the discharge may be performed while the temperature is increased. Furthermore, in regard to the temperature increase, the discharge may be performed during the temperature increase as in the second step or before/after the temperature increase.

In the fourth step, the temperature increase, cooling, and charging are each performed at least once. From a viewpoint of depositing the larger amount of lithium on the negative electrode material 35 upon completion of the fourth step, the number of repetitions of a set of the temperature increase, cooling, and charging may be two or more times, three or more times, five or more times, seven or more times, eight or more times, or ten or more times, and may be three or more times. In addition, as the number of the repetitions of the temperature increase, cooling, and charging is increased, the amount of lithium ions that can be absorbed by the negative electrode active material 37 during the temperature increase converges to a constant value. Thus, the excessive number of repetitions leads to energy loss. Accordingly, the number of the repetitions may be 30 times or less, 25 times or less, 20 times or less, 15 times or less, 10 times or less, or 8 times or less, and may be 10 times or less.

Due to the temperature increase during the fourth step, lithium that has been ionized again is absorbed in a region (active region), where lithium ion absorption capacity still remains, in the negative electrode active material 37. By repeating the deposition of lithium in subsequent cooling and charging and the absorption of lithium ions in the active region of the negative electrode active material 37 by the further temperature increase, an absorption amount of lithium ions in the entire negative electrode active material 37 converges to a constant upper limit value. Accordingly, by repeating the temperature increase, cooling, and charging in the fourth step for the suitable number of times, the larger amount of lithium can be deposited on the negative electrode material 35 than that in a case of executing up to the third step.

In the second embodiment, the description has been made on, as the example, the case where the second lithium deposition step S12 is executed after the lithium-ion battery 1 is provided in the form of the battery cell 3 in the reuse step S1. In the reuse step S1 and/or the second lithium deposition step S12, the lithium-ion battery 1 may be provided in the form of the battery pack or the battery module 4. In this case, the cooling/temperature increasing device 201 may be built in the battery pack or the battery module 4 in advance.

The reuse system 200 of the lithium-ion battery 1 according to the present disclosure may correspond to the configuration described in the above embodiment, or various modifications can be made thereto.

In the above embodiment, the description has been made on the example in which the lithium-ion battery is of the laminated type. In an implementation, a lithium-ion battery in a cylindrical shape or a polygonal shape may be adopted, which is formed by winding a belt-shaped laminated electrode body, in which a belt-shaped positive electrode material, a belt-shaped separator, and a belt-shaped negative electrode material are laminated in the lamination direction A, in a cylindrical shape or a square shape. In a case of the cylindrical shape or the polygonal shape, the lamination direction corresponds to a radial direction orthogonal to a winding direction.

Although the description has been made on a cell-by-cell basis, it may be implemented on a module-by-module basis or on a battery pack-by-battery pack basis. In a case of the implementation on the battery pack-by-battery pack basis, the pressing device, the cooling device, and the like may be provided in the battery pack in advance.

### Additional Remarks

According to the reuse system 200 of the lithium-ion battery 1 according to an embodiment, the following aspects are provided.

### First Aspect

The battery processing method for processing the lithium-ion battery including the positive electrode material and the negative electrode material, the battery processing method including:
the first step of charging the lithium-ion battery while cooling to deposit lithium on the negative electrode material;
the second step of increasing the temperature of the lithium-ion battery; and
the third step of charging the lithium-ion battery while cooling again to deposit lithium on the negative electrode material.

### Second Aspect

The battery processing method according to the first aspect in which
in the first step and/or the third step, cooling is performed at a rate of 0.1° C./min to 10° C./min.

### Third Aspect

The battery processing method according to the first or second aspect in which
in the second step, the temperature is increased by heating.

### Fourth Aspect

The battery processing method according to the third aspect in which
in the second step, the temperature is increased at a rate of 0.1° C./min to 20° C./min.

### Fifth Aspect

The battery processing method according to any one of the first to fourth aspects in which
in the second step, discharge is performed while the temperature is increased.

### Sixth Aspect

The battery processing method according to any one of the first to fifth aspects in which
in the first step and/or the third step, charging is performed by high-rate charging.

### Seventh Aspect

The battery processing method according to any one of the first to sixth aspects further including:
the fourth step repeated at least once, in the fourth step, after the third step, the temperature of the lithium-ion battery being increased to the predetermined temperature, and it being then charged while being cooled to deposit lithium on the negative electrode material.

### Eighth Aspect

The battery processing method according to any one of the first to seventh aspects further including:
the battery disassembly step of disassembling at least the negative electrode material from the lithium-ion battery; and
the lithium extraction step of extracting lithium from the negative electrode material.

### Ninth Aspect

The battery processing method according to the eighth aspect in which
in the lithium extraction step, lithium is selectively extracted from a specific portion of the negative electrode material.

### Tenth Aspect

A battery processing system for processing the lithium-ion battery including the positive electrode material and the negative electrode material, the battery processing system including:
the cooling device capable of cooling the lithium-ion battery and capable of controlling a cooled state and a non-cooled state; and
the charging device that charges the battery.

### Eleventh Aspect

The battery processing system according to the tenth aspect further including:
the temperature increasing device capable of increasing a temperature of the lithium-ion battery.

### Reference Signs List

1: lithium-ion battery
3: battery cell
4: battery module
10: reuse unit
12: charging device
20: recycle unit
21: disassembly device
22: extraction device
23: collection device
31: positive electrode material
34: separator
35: negative electrode material
38: laminated electrode body
39: electrolytic solution
40: case
200: reuse system
201: cooling/temperature increasing device

1. A battery processing method for processing a lithium-ion battery including a positive electrode material and a negative electrode material, the battery processing method comprising:
a first step of charging the lithium-ion battery while cooling to deposit lithium on the negative electrode material;
a second step of increasing a temperature of the lithium-ion battery; and
a third step of charging the lithium-ion battery while cooling again to deposit lithium on the negative electrode material.

2. The battery processing method according to claim 1, wherein, in the first step and/or the third step, cooling is performed at a rate of 0.1° C./min to 10° C./min.

3. The battery processing method according to claim 1, wherein, in the second step, the temperature of the lithium-ion battery is increased by heating.

4. The battery processing method according to claim 3, wherein, in the second step, the temperature is increased at a rate of 0.1° C./min to 20° C./min.

5. The battery processing method according to claim 4, wherein the temperature is increased by leaving the lithium-ion battery in a room temperature environment for a predetermined time.

6. The battery processing method according to claim 1, wherein the second step further includes discharging the lithium-ion battery.

7. The battery processing method according to claim 6, wherein, in the second step, discharging the lithium-ion battery is performed while the temperature is increased.

8. The battery processing method according to claim 1, wherein, in the first step and/or the third step, charging is performed by high-rate charging.

9. The battery processing method according to claim 1, further comprising:
performing a fourth step at least once after the third step, the fourth step including increasing temperature of the lithium-ion battery to a predetermined temperature, and charging the lithium-ion battery while cooling the lithium-ion battery to deposit lithium on the negative electrode material.

10. The battery processing method according to claim 1, further comprising:
a battery disassembly step of disassembling at least the negative electrode material from the lithium-ion battery; and
a lithium extraction step of extracting the lithium from the negative electrode material.

11. The battery processing method according to claim 10, wherein, in the lithium extraction step, lithium is selectively extracted from a portion of the negative electrode material.

12. The battery processing method according to claim 1, wherein the cooling is performed with a pair of cooling devices, the pair of the cooling devices being provided on both sides of the lithium-ion battery in a lamination direction of the lithium-ion battery.

13. The battery processing method according to claim 1, wherein cooling the lithium-ion battery includes cooling to a temperature of −50° C. or more and 20° C. or less.

14. A battery processing system for processing a lithium-ion battery including a positive electrode material and a negative electrode material, the battery processing system comprising:
a cooling device configured to cool the lithium-ion battery and configured to control a cooled state and a non-cooled state; and
a charging device that charges the battery.

15. The battery processing system according to claim 14, further comprising a temperature increasing device configured to increase a temperature of the lithium-ion battery.

16. The battery processing system according to claim 15, wherein:
the cooling device includes a plurality of cooler pairs,
the plurality of cooler pairs includes a central cooler pair configured to cool a central region of the lithium-ion battery and side cooler pairs configured to respectively cool both side regions of the lithium-ion battery.

17. The battery processing system according to claim 10, wherein the cooling device is configured to cool the lithium-ion battery cooling to a temperature of −50° C. or more and 20° C. or less.
